(19) United States
(12) Patent Application Publication
(10) Pub. No.: US 2003/0058304 A1
(43) Pub. Date: Mar. 27, 2003

(54) Inkjet apparatus and method of preventing misplacing inkjet cartridge therein

(76) Inventors: Chih-Ching Chen, Taipei (TW); Yi-Jing Leu, Hsinchu (TW); Der-Rong Shyu, Putz City (TW)

Correspondence Address: RABIN & BERDO, P.C., Suite 500, 1101 14th STREET, N.W., WASHINGTON, DC, 20005, US

(21) Appl. No.: 10/253,543

(22) Filed: Sep. 25, 2002

(30) Foreign Application Priority Data
Sep. 25, 2001 (TW) 090123658

(51) Int. Cl. B41J 2/21; B41J 2/14; B41J 2/16

(52) U.S. Cl. 347/43; 347/50

(57) ABSTRACT

An inkjet apparatus and a method of preventing misplacing the inkjet cartridge therein are disclosed. The inkjet apparatus comprises a carriage, a control unit and a sensor. The carriage is equipped with at least an inkjet cartridge that has an identifiable area. The color of the identifiable area is associated with the colors of ink stored in the inkjet cartridge. The sensor detects the color of the identifiable area and sends a signal to the control unit. The control unit receives the signal and determines whether the inkjet cartridge is correctly placed. If the inkjet cartridge is misplaced, a warning signal is generated to alert the user.

This application incorporates by reference of Taiwan application Serial No. 90123658, filed Sep. 25, 2001.

### BACKGROUND OF THE INVENTION

1. Field of the Invention

The invention relates in general to an inkjet apparatus and a method of preventing misplacing an inkjet cartridge therein, and more particularly to the method of preventing misplacing the inkjet cartridge by using a sensor to detect the color of an identifiable area of inkjet cartridge disposed in the carriage.

2. Description of the Related Art

The inkjet apparatus, such as copy machine, facsimile machine and inkjet printer, has become a necessity in the modern life. Recently, a multi-function printer (MFP) that combines the multiple functions (like copy machine, facsimile machine and inkjet printer) has been designed to meet the demands of the consumers all at once. It is very easy and time saving for the users to connect the inkjet printer to the computer and print out the documents/pictures/photos. The inkjet printer mainly includes a housing and a printing module situated inside the housing to perform the printing steps. The details of the printing module are described as follows.

FIG. 1 is a schematic drawing of a conventional printing module in the inkjet apparatus. The printing module 100 includes a carriage 102, a rod 104, a print platform 106 and the sidewalls 108a and 108b. The sidewalls 108a and 108b are set oppositely, and two ends of the rod 104 are respectively connected to the sidewalls 108a and 108b. The carriage 102, removably arranged on the rod 104, can move forward or backward over the print platform 106 along the direction of arrow 105, to accomplish the printing operation. The carriage 102 comprises the printed circuit boards (PCBs) 110a and 110b, the cartridge-setting slots 112a and 112b for placing the inkjet cartridges 114a and 114b therein. Also, there are flexible PCBs 116a and 116b attached at the surfaces 115a and 115b of the inkjet cartridges 114a and 114b, respectively. When the inkjet cartridges 114a and 114b are respectively put into the cartridge-setting slots 112a and 112b, the flexible PCBs 116a and 116b could electrically couple to the PCBs 110a and 110b at the carriage 102; therefore, the current conducted into the flexible PCBs 116a and 116b through the PCBs 110a and 110b and the printer could control the movement of the carriage 102 and drive the inkjet cartridges 114a and 114b to eject ink.

Generally, two inkjet cartridges are adapted in a printing module 100. One is a single-color cartridge 114b, usually filled with black ink. The other is a color cartridge 114a, having separated ink reservoirs and filled with different color inks such as cyan, magenta, and yellow ink. In the commercial inkjet printer market, there are other colors of ink to be used, such as light black, light cyan, light magenta, and light yellow.

However, the similar external appearances of the conventional homochromatic cartridge and the color cartridge confuse the user all the time. Consequently, the misplacement of cartridges in the carriage 102 occurs and it has effect on the printing result. In order to put the homochromatic cartridge 114b and the color cartridge 114a into the correct positions at the carriage 102, which means that the flexible PCBs 116a and 116b are electrically coupled to the PCBs 110a and 110b, some manufacturers try to make a difference between both cartridges; for example, a difference in size. As shown in FIG. 1, the size of the cartridge 114a is larger than that of the cartridge 114b; correspondingly, the space of cartridge setting slot 112a is larger than that of the cartridge setting slot 112b. The inkjet cartridge can only be installed in the size-matched cartridge setting slot. Accordingly, the misplacement of cartridge can be prevented.

Also, some manufacturers make an improvement in the configuration of the cartridge, so that the user can visually distinguish the cartridge model and its matched cartridge setting slot. However, the cartridges are usually produced into a whole. Change the configuration of the cartridge will raise the production cost.

### SUMMARY OF THE INVENTION

It is therefore an object of the invention to provide an inkjet apparatus and a method of preventing misplacing inkjet cartridge therein. At least a sensor is used to detect the color of the identifiable area at the inkjet cartridge and then send a signal to a control unit. It is very convenient that the control unit can determine whether the inkjet cartridge is misplaced and alerts the user to the misplaced condition.

It is an object of the invention to provide an inkjet apparatus, having a carrier equipped with at least one inkjet cartridge. The inkjet cartridge has an identifiable area, and the color of the identifiable area is associated with the colors of ink stored in the inkjet cartridge. The inkjet apparatus comprises a control unit and a sensor. The sensor detects the color of the identifiable area and sends a signal to the control unit. The control unit receives the signal and determines whether the inkjet cartridge is correctly placed.

It is another object of the invention to provide a method of preventing misplacing inkjet cartridge. The method is adapted to an inkjet apparatus. The inkjet apparatus has a carriage, a sensor and a control unit. The carriage is equipped with an inkjet cartridge, and the inkjet cartridge has an identifiable area, which the color of the identifiable area is associated with the color of ink stored in the inkjet cartridge. The method comprises the steps of: (1) detecting the color of the identifiable area and sending a signal by the sensor; and (2) receiving the signal and telling whether the inkjet cartridge is placed in the right position by the control unit. If the inkjet cartridge is misplaced, a warning signal is send to alert the user.

It is still another object of the invention to provide an inkjet apparatus having a carriage equipped with a first printed circuit board (PCB) and a second PCB. When a first inkjet cartridge and a second inkjet cartridge are placed in the carriage, a first flexible PCB of the first inkjet cartridge and a second flexible PCB of the second inkjet cartridge are electrically coupled to the first PCB and the second PCB of the carriage, respectively. The first flexible PCB and the second flexible PCB respectively have a first identifiable area and a second identifiable area, wherein the colors of the first identifiable area and the second identifiable area are associated with the colors of ink stored in the first inkjet cartridge and the second inkjet cartridge. The inkjet apparatus comprises a first sensor, a second sensor and a control unit. The first sensor is positioned at the carriage for detecting the color of the first identifiable area and sending a first signal. The second sensor is positioned at the carriage for detecting the color of the second identifiable area and sending a second signal. The control unit receives the first signal and the second signal and determines whether the first inkjet cartridge and the second inkjet cartridge are correctly placed in the right positions.

It is still another object of the invention to provide a method of preventing misplacing inkjet cartridge, and the method is adapted to an inkjet apparatus. The inkjet apparatus has a carriage, a first sensor, a second sensor, and a control unit. The carriage is equipped with a first PCB and a second PCB. When a first inkjet cartridge and a second inkjet cartridge are placed in the carriage, a first flexible PCB of the first inkjet cartridge and a second flexible PCB of the second inkjet cartridge are electrically coupled to the first PCB and the second PCB of the carriage, respectively. The first flexible PCB and the second flexible PCB respectively have a first identifiable area and a second identifiable area, wherein the colors of the first identifiable area and the second identifiable area are associated with the colors of ink filled in the first inkjet cartridge and the second inkjet cartridge. The method comprises the steps of: (1) detecting the colors of the first identifiable area and the second identifiable area, and sending a first signal and a second signal by the first sensor and the second sensor, respectively; and (2) receiving the first signal and the second signal, and determining whether the first inkjet cartridge and the second inkjet cartridge are correctly placed in the right positions by the control unit. If the inkjet cartridges are misplaced, a warning signal is send to alert the user.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 (Prior Art) is a schematic drawing of a conventional printing module in the inkjet apparatus;

FIG. 2 is a schematic drawing of a printing module in the inkjet apparatus according to the preferred embodiment of the invention;

FIG. 3 shows the connections between the control unit, sensors and identifiable areas; and

FIG. 4 is a flow chart representing a method of preventing the misplacement of inkjet cartridge according to the preferred embodiment of the invention.

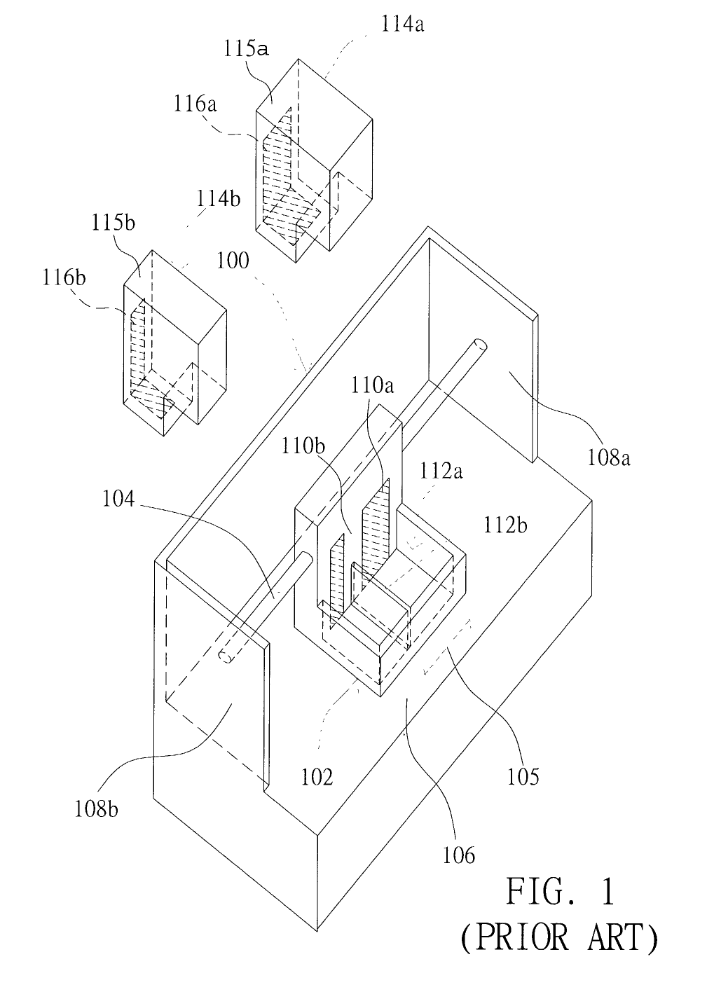

### DETAILED DESCRIPTION OF THE INVENTION

An inkjet apparatus and a method of preventing misplacing the inkjet cartridge in the inkjet apparatus are disclosed. The inkjet apparatus mainly includes a housing and a printing module. The printing module situated inside the inkjet apparatus includes a control unit and a carriage. At least an inkjet cartridge is equipped in the carriage, wherein the cartridge has an identifiable area and its color is corresponding to the color of ink stored in the cartridge. In the invention, a sensor is used to detect the identifiable area at the inkjet cartridge, and then send a signal to the control unit that determines whether the inkjet cartridge is misplaced and alerts the user to the misplaced condition. The inkjet apparatus could be an inkjet printer, inkjet facsimile machine, inkjet copy machine, or multi-function printer (MFP) combining the functions thereof. The sensor used in the inkjet apparatus could be a charged coupling device (CCD), or contact image sensor (CIS). In this preferred embodiment, the printing module equipped with two inkjet cartridges in the inkjet apparatus of the invention is taken for illustration, and the details are described below.

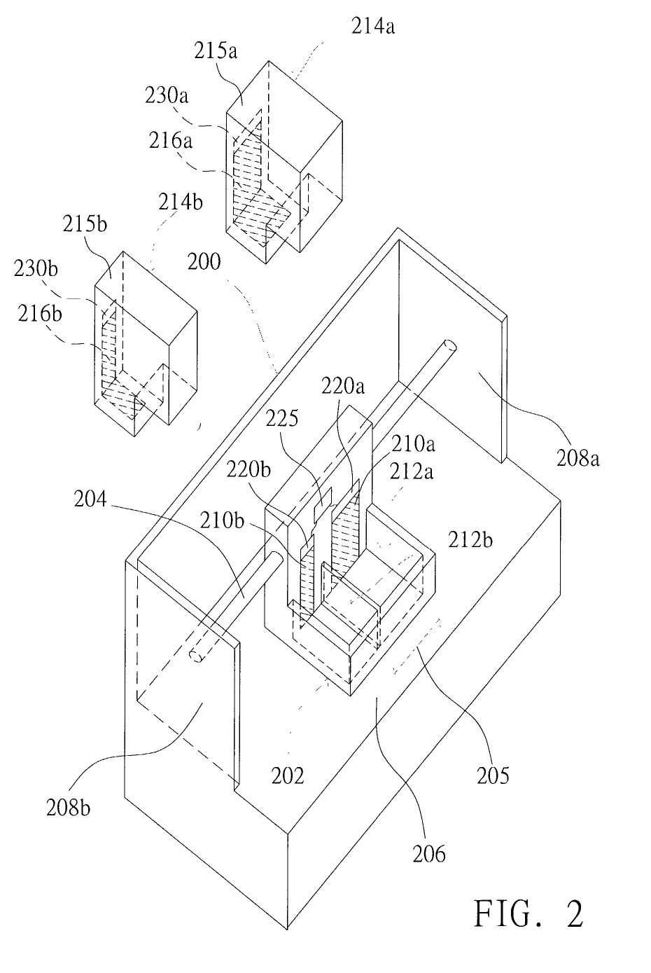

FIG. 2 is a schematic drawing of a printing module in the inkjet apparatus according to the preferred embodiment of the invention. The printing module 200, situated inside the housing of the inkjet apparatus, includes a carriage 202, a rod 204, a print platform 206 and the sidewalls 208a and 208b. The sidewalls 208a and 208b are set oppositely, and two ends of the rod 204 are respectively connected to the sidewalls 208a and 208b. The carriage 202, removably mounted on the rod 204, can move forward or backward over the print platform 206 along the direction of arrow 205 during printing operation. The carriage 202 comprises a control unit 225, the sensors 220a and 220b, the printed circuit boards (PCBs) 210a and 210b, the cartridge-setting slots 212a and 212b for receiving the inkjet cartridges 214a and 214b. Also, there are flexible PCBs 216a and 216b attached at the surfaces 215a and 215b of the inkjet cartridges 214a and 214b, respectively. Alternatively, the PCBs 210a and 210b could be designed as one integrated PCB.

When the inkjet cartridges 214a and 214b are respectively put into the cartridge-setting slots 212a and 212b, the flexible PCBs 216a and 216b could electrically couple to the PCBs 210a and 210b at the carriage 202; therefore, the currents conducted into the flexible PCBs 216a and 216b through the PCBs 210a and 210b, and the printer could control the movement of the carriage 202 and drive the inkjet cartridges 214a and 214b to eject ink. If the user misplaces the cartridges 214a and 214b into the wrong slots (212a and 212b), the printing operation is terminated and not to be performed.

In this preferred embodiment, the cartridge 214b is a single-color cartridge filled with black ink, while the cartridge 214a is a color cartridge filled with three different colors of ink such as cyan, magenta and yellow. In the practical application, the color of ink filled in the cartridge could optionally be cyan, magenta, yellow, light black, light cyan, light magenta and light yellow. Additionally, the identifiable areas 230a and 230b are further formed at the flexible PCBs 216a and 216b, and designed for helping the user tell the color of ink in the cartridge. The colors of the identifiable areas 230a and 230b are associated with the colors of ink in the cartridges 214a and 214b, respectively. Also, the identifiable areas 230a and 230b could be formed by adding the related colorants on the flexible PCBs during the flexible PCB fabrication. Therefore, the user immediately knows the colors of ink in the cartridges 214a and 214b by looking at the identifiable areas 230a and 230b. Although the identifiable areas 230a and 230b in FIG. 2 only take parts of the spaces in the flexible PCBs 216a and 216b, the areas could be optionally changed. For example, the identifiable areas 230a and 230b could have the identical size with the flexible PCBs 216a and 216b.

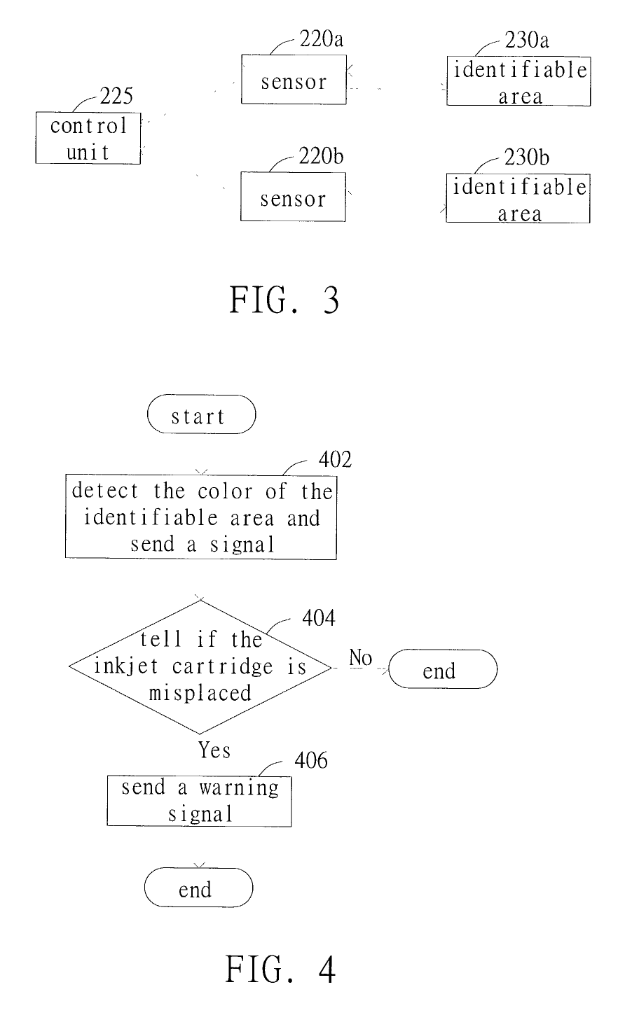

Moreover, the control unit 225, and the sensors 220a and 220b are further equipped at the carriage 202 to prevent the misplacement of the cartridge. The sensors 220a and 220b, respectively positioned at the PCBs 210a and 210b, are electrically connected to the control unit 225. FIG. 3 shows the connections between the control unit, sensors and identifiable areas. The sensors 220a detects the color of the identifiable area 230a, and send a first signal to the control unit 225. Similarly, the sensors 220b detects the color of the identifiable area 230b, and send a second signal to the control unit 225. The control unit 225 receives the first signal and the second signal from the sensors 220a and 220b, whereby the placements of the inkjet cartridges 214a and 214b in the carriage 202 can be determined. Alternatively, the control unit 225 could be set on the main board (not shown) of the inkjet apparatus instead of at the carriage 202.

FIG. 4 is a flow chart representing a method of preventing the misplacement of inkjet cartridge according to the preferred embodiment of the invention. In step 402, the sensors 220a and 220b respectively detect the colors of the identifiable area 230a and 230b, and then transmit the first signal and the second signal. Then, the control unit receives the first and the second signals, and determines whether the inkjet cartridges 214a and 214b are correctly placed at the right positions. If the determination is positive (the cartridges are at right positions), the printing operation is allowed to proceed and this process ends; otherwise, the system is led to step 406. When the inkjet cartridges 214a and 214b are misplaced at the slots 212b and 212a, the control unit 225 would send a warning signal like a sound or a sign to alert the user. So, both of the inkjet cartridges could be switched or changed.

Although the identifiable areas formed by the chemical method such as adding the colorants in the flexible substrate of PCB is illustrated in this preferred embodiment, the invention is not limited herein. The color tags can be directly attached to a surface of the housing of the cartridges, wherein the attached positions are corresponding to the sensors' positions and the tag colors are associated with the ink colors. Since the carriage usually moves to the home position while the printer is on, both of the sensors could be arranged at the inner wall of the housing of printer and quite near the home position, to detect the identifiable areas at the cartridges. Alternatively, the detection of identifiable area could be accomplished by one removable sensor instead of two fixed sensors. Also, the signals between the sensors to the control unit could be transmitted/received by the wireless method, such as infrared (IR) data association, RF transmission or radio transmission.

Moreover, several models of the inkjet cartridges can be differentiated by the different colors of the identifiable areas. For example, one model has a black identifiable area while the other model has a gray identifiable area, so as to differentiate the different models of the inkjet cartridges both containing black ink. Hence, the user will understand if the right model of cartridge is adopted in the inkjet apparatus.

In summary, the sensor of the invention is used to detect the identifiable area at the inkjet cartridge, and then send a signal to the control unit that determines whether the inkjet cartridge is misplaced and informs the user. Accordingly, neither the differentiable size of the cartridges or the matched appearance of the placing slots is required for preventing misplacing inkjet cartridges. Whether the inkjet cartridges are misplaced is only determined by the detection of the sensor. Consequently, the cost of pattern-making in the present invention can be decreased.

While the invention has been described by way of example and in terms of preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An inkjet apparatus, having a carriage equipped with a printed circuit board (PCB), a first flexible PCB and a second flexible PCB respectively disposed in a first inkjet cartridge and a second inkjet cartridge electrically coupling to the PCB on the carriage, the first inkjet cartridge and the second inkjet cartridge respectively having a first identifiable area and a second identifiable area, wherein the colors of the first identifiable area and the second identifiable area are associated with the colors of ink stored in the first inkjet cartridge and the second inkjet cartridge, the inkjet apparatus comprising:
a first sensor, disposed in the carriage for detecting the color of the first identifiable area and sending a first signal;
a second sensor, disposed in the carriage for detecting the color of the second identifiable area and sending a second signal; and
a control unit for receiving the first signal and the second signal, and determining whether the first inkjet cartridge and the second inkjet cartridge are correctly placed.

2. The inkjet apparatus according to claim 1, wherein the control unit sends a warning signal to alert a user when the first inkjet cartridge or the second inkjet cartridge is misplaced.

3. The inkjet apparatus according to claim 1, wherein the carriage is equipped with a first printed circuit board (PCB) and a second PCB, wherein the first PCB and the second PCB are electrically coupled to the first flexible PCB of the first inkjet cartridge and the second flexible PCB of the second inkjet cartridge, respectively.

4. The inkjet apparatus according to claim 3, wherein the first sensor and the second sensor are positioned at the first PCB and the second PCB, respectively.

5. The inkjet apparatus according to claim 1 further comprising a housing, wherein the first sensor and the second sensor are disposed in an inside wall of the housing.

6. The inkjet apparatus according to claim 1, wherein the first identifiable area and the second identifiable area are formed at the first flexible PCB of the first inkjet cartridge and the second flexible PCB of the second inkjet cartridge, respectively.

7. The inkjet apparatus according to claim 1, wherein the first inkjet cartridge has a first surface and the second inkjet cartridge has a second surface, wherein the first identifiable area and the second identifiable area are located at the first surface and the second surface, respectively.

8. The inkjet apparatus according to claim 1, wherein the first signal and the second signal are wirelessly transmitted between the control unit, the first sensor and the second sensor.

9. A method of preventing misplacing inkjet cartridge, adapted for an inkjet apparatus, the inkjet apparatus having a carriage equipped with a first inkjet cartridge and a second inkjet cartridge, the first inkjet cartridge and the second inkjet cartridge respectively having a first identifiable area and a second identifiable area, wherein the colors of the first identifiable area and the second identifiable area are associated with the colors of ink stored in the first inkjet cartridge and the second inkjet cartridge, the method comprising the steps of:
detecting the colors of the first identifiable area and the second identifiable area;
sending a first signal and a second signal;
receiving the first signal and the second signal; and
determining whether the first inkjet cartridge and the second inkjet cartridge are correctly placed.

10. The method according to claim 9, further comprising a step of:
sending a warning signal to alert a user while the first inkjet cartridge or the second inkjet cartridge is misplaced.

11. The method according to claim 9, wherein the first inkjet cartridge has a first flexible PCB and the second inkjet cartridge has a second flexible PCB, wherein the first identifiable area and the second identifiable area are disposed at the first flexible PCB and the second flexible PCB, respectively.

12. The method according to claim 9, wherein the first inkjet cartridge has a first surface and the second inkjet cartridge has a second surface, wherein the first identifiable area and the second identifiable area are located at the first surface and the second surface, respectively.

13. An inkjet apparatus, having a carriage equipped with at least an inkjet cartridge, the inkjet cartridge having an identifiable area, and the color of the identifiable area is associated with the colors of ink stored in the inkjet cartridge, the inkjet apparatus comprising:
a sensor, for detecting the color of the identifiable area and sending a signal; and
a control unit, for receiving the signal and determining whether the inkjet cartridge is correctly placed.

14. The inkjet apparatus according to claim 13, wherein the sensor is a charged coupling device (CCD).

15. The inkjet apparatus according to claim 13, wherein the sensor is a contact image sensor (CIS).

16. The inkjet apparatus according to claim 13, wherein the sensor is disposed in the carriage.

17. The inkjet apparatus according to claim 13 further comprising a housing, wherein the sensor is disposed in an inside wall of the housing.

18. The inkjet apparatus according to claim 13, wherein the inkjet cartridge further comprises a flexible PCB, and the identifiable area is formed at the flexible PCB.

19. The inkjet apparatus according to claim 13, wherein the inkjet cartridge further comprises a surface and the identifiable area is located at the surface of the inkjet cartridge.

20. The inkjet apparatus according to claim 13, wherein the signal is wirelessly transmitted between the control unit and the sensor.

21. A method of preventing misplacing inkjet cartridge, adapted for an inkjet apparatus, the inkjet apparatus having a carriage equipped with an inkjet cartridge, the inkjet cartridge having an identifiable area, wherein the color of the identifiable area is associated with the color of ink stored in the inkjet cartridge, the method comprising the steps of:
detecting the color of the identifiable area, and sending a signal; and
receiving the signal and determining whether the inkjet cartridge is correctly placed.

22. The method according to claim 21, further comprising a step of:
sending a warning signal to alert a user while the inkjet cartridge is misplaced.

23. The method according to claim 21, wherein the inkjet apparatus comprises a control unit to receive the signal and determine whether the inkjet cartridge is misplaced.

24. The method according to claim 21, wherein the inkjet apparatus has a sensor to detect the color of the identifiable area and send the signal.

25. The method according to claim 24, wherein the sensor is disposed in the carriage.

26. The method according to claim 24, wherein the inkjet cartridge further has a housing, and the sensor is disposed in an inside wall of the housing.

27. The method according to claim 21, wherein the inkjet cartridge has a flexible PCB, and the identifiable area is formed at the flexible PCB.

28. The method according to claim 21, wherein the inkjet cartridge has a surface and the identifiable area is located at the surface of the inkjet cartridge.
